(19) United States
(12) Patent Application Publication
(10) Pub. No.: US 2017/0199299 A1
(43) Pub. Date: Jul. 13, 2017

(54) Method of Configuring and of Operating a Monitored Automated Work Cell and Configuration Apparatus

(71) Applicant: SICK AG, Waldkirch (DE)

(72) Inventor: Ingolf BRAUNE, Waldkirch (DE)

(21) Appl. No.: 15/363,638

(22) Filed: Nov. 29, 2016

(30) Foreign Application Priority Data
Jan. 7, 2016 (EP) 16150475.8

(51) Int. Cl. G01V 8/18; B25J 19/06; B25J 9/16; H04L 29/08; H04L 12/24

(52) U.S. Cl. CPC G01V 8/18; H04L 67/12; H04L 41/08; B25J 9/1674; B25J 19/06

(57) ABSTRACT

A method of configuring and of operating a monitored automated work cell, wherein the work cell has at least one dangerous machine and at least one monitoring device includes the following steps: transmitting machine space data defining at least one work space of the machine to a configuration apparatus for the monitoring device; generating protective space data by the configuration apparatus using the machine space data, with the protective space data defining at least one protective space of the monitoring device which encompasses the work space of the machine such that the protective space completely or partly corresponds to the work space or that the protective space is larger than the work space; and transferring the protective space data to the monitoring device so that the monitoring device monitors the protective space; and a configuration device for configuring a monitoring device monitoring an automated work cell.

The present invention relates to a method of configuring and of operating a monitored automated work cell and to a configuration apparatus for configuring a monitoring device monitoring an automated work cell.

Automated work cells which are controlled by a central production control and which carry out production steps completely autonomously are being used more and more in the automation industry. In this respect, the automated work cells have at least one dangerous machine which is, for example, in the form of a multi-axial robot. The multi-axial robot is dangerous to the factory personnel due to its large mass and its fast kinematic movement sequences so that a robot control has a large number of safety functions to ensure a safe operation of the multi-axial robot or of the work cells without interruptions. Movement sequences of the robot are programmed and taught in this respect in a safe and collision-free manner so that the robot and in particular its tool center point and its joints can be moved without danger in a defined work space.

To ensure the safe operation of the work cells, the work cells are monitored by means of at least one additional monitoring device, with the monitoring device being provided to check a protective space around the multi-axial robot for whether a person or an object is present in the checked protective space or whether a collision with an obstacle or a person could take place.

In this respect, the protective space forms a part region of a total field of vision of the monitoring device and coincides, at least partly, with the work space of the multi-axial robot. If there is no risk of a collision, the operation of the multi-axial robot is released. After a release of operation of the multi-axial robot, the protective space or part regions of the protective space continue to be permanently monitored by the monitoring device. If there is a risk of a collision, the monitoring device triggers a safe stop of the multi-axial robot.

On a flexibilization of production processes, it is frequently unavoidable to provide a collaboration between the automated machine and the operator. There is hereby the necessity that the monitoring device has to detect and evaluate the protective space of the automated machine, in particular in a manner adapted to the different production steps and to flexible worksteps.

In other words, the monitoring device has to distinguish between the contour of the automated machine and of the operator. This requires, as disclosed in EP 2 275 990 B1, a highly complex and thus expensive monitoring device or evaluation logic and a high computing capacity of a control unit of the monitoring device to constantly adapt the protective space of the monitoring device dynamically to the movement of the machine.

The work cell, in particular the movement sequences of the multi-axial robot, and the monitoring device are furthermore currently programmed and configured independently of one another. Programming and configuring in this context mean a generation of geometrical data of the work space of the machine or of the protective space of the monitoring device in dependence on a coordinate system of the machine and of a coordinate system of the monitoring device.

A change of functions or sequences in the automated work cell is hereby associated with a high work effort and costs.

It is an object of the present invention to provide a method of configuring and of operating a monitored automated work cell which allows an inexpensive operation, simple installations and uncomplicated adaptations with a high safety of the work cell.

The object is satisfied in accordance with the invention by a method of configuring and of operating a monitored automated work cell, wherein the work cell has at least one dangerous machine and at least one monitoring device, with the method comprising the following steps: transmitting machine space data defining at least one work space of the machine to a configuration apparatus; generating protective space data by the configuration apparatus using the machine space data, with the protective space data defining at least one protective space of the monitoring device which encompasses the work space of the machine such that the protective space completely or partly corresponds to the work space or that the protective space is larger than the work space and transferring the protective space data to the monitoring device so that the monitoring device monitors the protective space.

A further advantage results in that a safe and simple configuration of the work cell can be ensured since the machine space data of the machine defining the work space can also be present in taught form and the protective space data of the monitoring device defining the protective space can be derived simply from these machine space data.

In accordance with a preferred embodiment, the machine space data and the protective space data are checked for consistency and only release the configuration of the protective space of the monitoring device on a correct parameterization and coordination between the machine space data and the protective space data. The correctness of the protective space configuration of the monitored automated work cell can hereby be ensured.

In accordance with a further preferred embodiment, the machine space data are generated by a machine control of the machine in dependence on a coordinate system of the machine. The protective space data are advantageously adapted to the coordinate system of the machine.

The internal coordinate systems of the machine and of the monitoring device with respect to one another are registered for this purpose. The further exchange of data can hereby advantageously take place with reference to a coordinate system.

The advantage results from this that the automated work cell, in particular the work space of the machine and the protective space of the monitoring device, can be configured or changed very flexibly, with all the data, both the machine space data and the protective space data, being adapted to a common coordinate system.

In accordance with a further preferred embodiment, the protective space is changed manually or automatically such that the protective space is increased by at least one additional protective space with respect to the work space. It is furthermore advantageous that the first protective space and the additional protective spaces are activated and deactivated differently in dependence on a trajectory of the machine.

In accordance with a further preferred embodiment, the steps of transmitting the machine space data, of generating the protective space data, and of transferring the protective space data are carried out in a fully automated manner and only the step of releasing the work cell is carried out manually after a check. The protective space data can furthermore be adapted manually or additional protective spaces can also be configured.

In accordance with a further preferred embodiment, the machine space data define a plurality of work spaces and the protective space data generated from the machine space data correspond to a plurality of protective spaces which coincide with the respective work spaces in a covering manner. The advantage results from this that the protective spaces of the monitoring device can be adapted to the work spaces of the machine in a time-saving manner and without gaps. This is of advantage when the machine covers alternative regions, e.g. for blank parts and finished parts. It is also of advantage here to supplement the protective spaces of the work regions with further upstream protective spaces.

In accordance with a further preferred embodiment, the machine space data comprise spatial coordinates of the coordinate system of the machine, with the machine space data being generated in a language specific to the machines, and the protective space data likewise comprise spatial coordinates of the coordinate system of the machine, with the protective space data being generated in a language specific to the monitoring device.

It is furthermore an object of the invention to provide a configuration apparatus for configuring a monitoring device which monitors an automated work cell and which allows inexpensive operation, simple installations and uncomplicated adaptations with a high safety of the work cell.

The object is satisfied in accordance with the invention by a configuration apparatus for configuring a monitoring device monitoring an automated work cell, wherein the work cell has at least one dangerous machine, in particular a multi-axial robot, and the monitoring device has a control unit. The configuration apparatus comprises a reception unit for receiving machine space data which define at least one work space of the machine; a generation unit for generating protective space data from the machine space data, with the protective space data defining at least one protective space of the monitoring device which encompasses the work space of the machine such that the protective space completely or partly corresponds to the work space or that the protective space is larger than the work space; and a transfer unit for transferring the protective space data to the control unit of the monitoring device so that the monitoring device monitors the protective space.

In accordance with a preferred embodiment, the configuration apparatus is physically separate from the machine control of the machine and from the monitoring device or is physically provided in the monitoring device.

In accordance with a further preferred embodiment, the machine space data and the protective space data are based on a common coordinate system, preferably on the coordinate system of the machine.

Since the machine space data and the protective space data can be generated with respect to the common coordinate system, the advantage results from this that the data of the machine and of the monitoring device can be simply adapted to one another so that a flexible configuration of the work cells can be carried out in a time-saving manner. The coordinate system advantageously comprises a Cartesian coordinate system or a polar coordinate system.

In accordance with a further preferred embodiment, the generation unit of the configuration apparatus is adapted to expand the protective space data manually or automatically by a predefinable value range such that the protective space defined by the protective space data is increased by at least one additional protective space.

In accordance with a further preferred embodiment, a test unit is provided to test the machine space data and the protective space data for coincidence in their coordinates. Defective gaps between the work space of the machine and the protective space of the monitoring device can thereby be safely identified and corrected.

In accordance with a further preferred embodiment, an acknowledgment unit is provided for releasing the configuration of the protective space of the monitoring device on a consistency between the machine space data and the protective space data and on a correct parameterization and coordination between the machine space data and the protective space data. A correct implementation of the safety demands to the configuration for monitoring the work cell is hereby ensured.

Preferred embodiments and further developments as well as further advantages of the invention can be seen from the dependent claims, from the following description and from the drawings.

The invention will be explained in detail in the following with reference to embodiments and to the drawings. There are shown in the drawings:

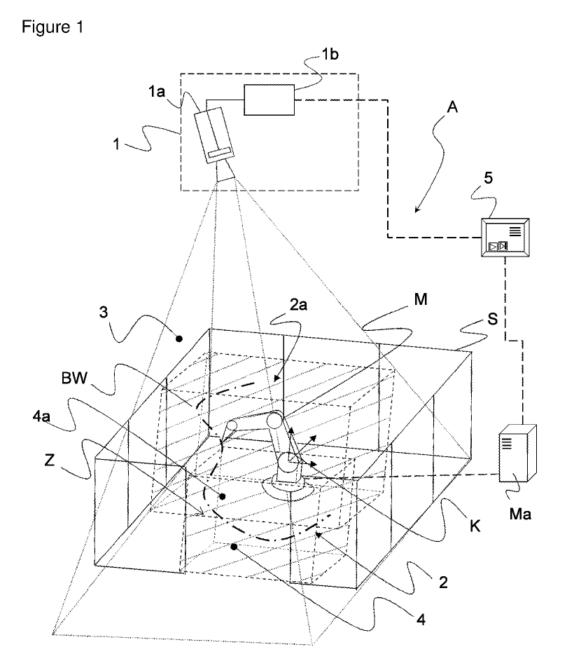

FIG. 1 a schematic representation of a work cell monitored and automated in accordance with the invention;

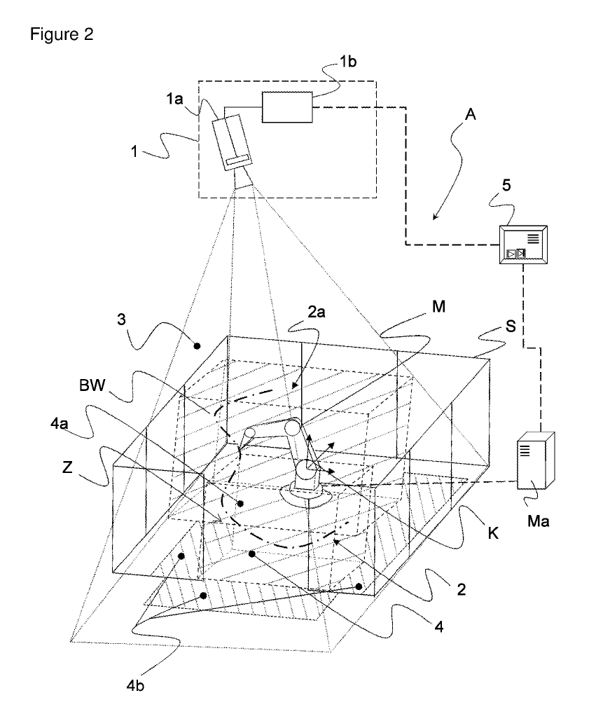

FIG. 2 a schematic representation of a preferred embodiment of a work cell configured in accordance with the invention; and

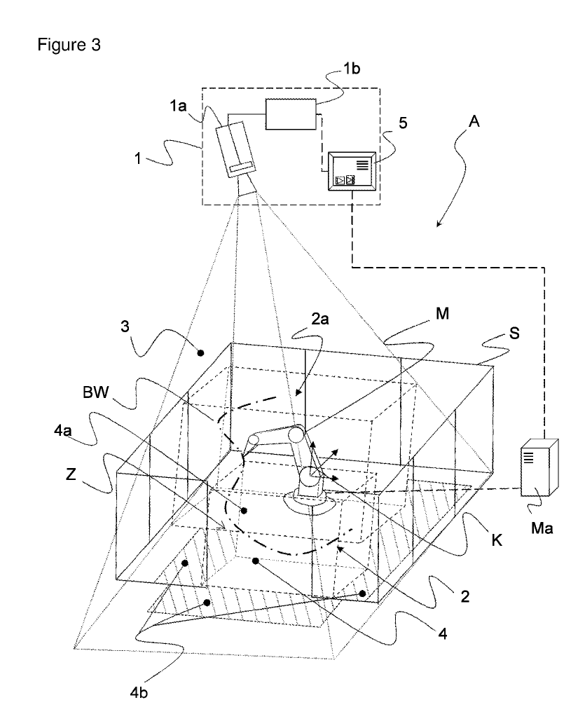

FIG. 3 a further schematic representation of the preferred embodiment of FIG. 2.

A monitored automated work cell A is shown in FIG. 1 which comprises a dangerous machine M in the form of a multi-axial robot and a monitoring device 1. The machine A is installed in the work cell A and is preferably surrounded by a protective fence S, with the protective fence S having at least one access Z to the machine M. An operator can move through the access Z into the work cell A and thus into the proximity of the dangerous machine M.

A coordinate system K is assumed at the machine M so that machine space data are generated with respect to the coordinate system K which define a work space 2, 2a of the machine M or of the robot. In this respect, the defined work space 2, 2a of the machine M comprises all the trajectories or movement sequences BW of the machine M during its operation which are produced by programming the machine M or by so-called teaching. The machine space data can be present both in Cartesian coordinates and in polar coordinates, with the machine space data including the spatial coordinates of the work space 2, 2a of the machine M. In this respect, the machine space data are generated in a language specific to the machines M which is predefined by the machine manufacturer.

The work space 2, 2a of the machine M lies within a fenced-in region of the protective fence S, with a plurality of work spaces 2 and 2a, which are spaced apart or contiguous, also being able to be provided in accordance with an application.

The total fenced-in region of the protective zone S is preferably in the field of vision 3 of the monitoring device 1, with the field of vision 3 of the monitoring device 1 furthermore covering an access space 4 to the fenced-in region of the protective fence S and thus to the work space 2, 2a of the machine M.

The monitoring device 1 preferably comprises at least one safe camera or at least one safe scanner. The safe camera or the safe scanner forms a detection unit 1a of the monitoring device 1 which detects the work space 2, 2a and the access space 4 of the work cell A. The monitoring device 1 comprises a control unit 1b which controls the monitoring device 1 and initiates a safe state of the dangerous machine M, e.g. a safe pausing or a safe stop, in a dangerous situation.

In a method in accordance with the invention, the machine space data of the machine M are transmitted by a machine control Ma of the machine M or by a higher ranking system control, e.g. a safety PLC, to a configuration apparatus 5, with the machine space data including exact geometrical coordinates of the work space 2, 2a of the dangerous machine M. Protective space data which define at least one protective space 4, 4a of the monitoring device 1 are generated by the configuration apparatus 5 using the machine space data, with the protective space 4, 4a being identical to the work space 2, 2a of the machine M. The protective space data are transferred to the monitoring device 1 so that the work cell A can be started and can be monitored by the monitoring device 1.

The generated protective space data are checked for coincidence between the work space 2, 2a and the protective space 4, 4a and the work cell A is released on coincidence

In this respect, coincidence means that the boundary lines of the work space 2, 2a of the machine M correspond to the boundary lines of the protective space 4, 4a of the monitoring device 1. The configuration of the work cell A, in particular the adaptation of the protective space 4, 4a of the monitoring device 1 to the work space 2, 2a of the machine M, is hereby made more failsafe since no insecure gaps can arise between the protective space 4, 4a of the monitoring device 1 of the work space 2, 2a of the machine M due to non-configured or unadapted borders.

In other words, the configuration apparatus 5 receives the machine space data from the machine control Ma or from the higher ranking system control by means of a reception unit and generates protective space data, which define at least one protective space 4, 4a of the monitoring device 1, using the machine space data by means of a generation unit, with the protective space 4, 4a of the monitoring device 1 being partly or completely identical to the work space 2, 2a of the machine M or being larger than the work space 2, 2a of the machine M. The protective space data include the exact geometrical coordinates of the protective space 4, 4a and are advantageously based on the coordinate system K of the machine M. The protective space data are furthermore generated in a language specific to the monitoring device 1.

It is hereby advantageous that the operator of the work cell A does not have to manually adapt the protective space 4, 4a of the monitoring device 1 to the work space 2, 2a of the machine M so that the work cell A is monitored and protected by the monitoring device 1.

A transfer unit of the configuration apparatus 5 transmits the generated protective space data to the control unit 1b of the monitoring device 1 so that the work space 2, 2a of the machine M can be monitored safely and without gaps by the monitoring device 1.

A checking unit of the configuration apparatus 5 preferably checks for a consistency between the work space 2, 2a of the machine M and the protective space 4, 4a of the monitoring unit 1 using the machine space data and the protective space data.

On consistency of the machine space data and the protective space data, the work cell A is released by means of an acknowledgment unit of the monitoring device 1. In accordance with the invention, the monitoring device 1 thereby receives the geometrical coordinates for its protective space 4, 4a to safely monitor the work space 2, 2a of the machine M.

It is advantageously secured by the check for consistency between the work space 2, 2a and the protective space 4, 4a that the configuration of the protective space 4, 4a of the monitoring device 1 is in a current state and the configured protective space 4, 4a behaves free of conflict with respect to the work space 2, 2a of the machine M predefined by the machine control Ma.

In the event that, for process reasons, the geometrical coordinates, i.e. the machine space data, of the work space 2, 2a of the machine M are changed, it is possible in a very simple manner in accordance with the invention to adapt the geometrical coordinates, i.e. the protective space data, of the protective space 4, 4a of the monitoring device 1 accordingly. The configuration of the work cell A can thus still be carried out simply and flexibly. It is advantageous in this respect that the steps of transmitting the machine space data, of generating the protective space data, of checking for the coinciding coverage and of transferring the protective space data to the monitoring device 1 are carried out fully automatically and only the step of releasing the configuration of the work cell A is carried out manually.

Furthermore, on a change of the configuration, i.e. of the machine space data of the work space 2, 2a of the machine M and correspondingly also of the protective space data of the protective space 4, 4a of the monitoring device 1, an automatic comparison of the data can take place in a more failsafe manner and the operator can be guided by means of a collision list or change list to points in the configuration to be checked or to be changed, whereby the configuration change can be carried out more simply, more safely and more reliably.

It is advantageously shown in FIG. 2 that the protective space 4, 4a defined by the protective space data is changeable or changed manually or automatically so that the protective space 4 is increased by additional protective spaces 4b with respect to the work space 2, 2a.

I.e. the reception unit of the configuration apparatus 5 receives the machine space data of the work space 2, 2a from the machine control Ma of the machine M or from the higher ranking system control and the generation unit of the configuration apparatus 5 generates the protective space data for the protective space 4, 4a of the monitoring device 1.

Additionally, in accordance with the embodiment, further additional protective spaces 4b which encompass the access Z to the work cell A and marginal regions between the work space 2, 2a of the machine M and the protective fence S, for example, are generated or defined about the generated protective space 4, 4a. Provision is preferably made in this respect that the protective space data defining the protective space 4, 4a and coinciding with the data of the work space 2, 2a are extended by a predefinable value range, for example protective space data plus one meter, so that the protective space 4, 4a defined by the protective space data is increased by at least one additional protective space 4b, for example by one meter in all directions of the coordinate system K of the machine M.

The additional protective space 4b, in particular in the region of the access Z, allows the monitoring unit 1 to provide an accelerated response time to an infringement of the protective space 4b so that a warning can be output to the operator or so that the machine can gently be slowed down, whereby the work cell A does not necessarily have to stop as a safe response when the operator leaves the additional protective space 4b again or the movement speed can also be limited to a non-dangerous level and tactile protective systems can be activated.

It is in particular possible by the provision of the additional protective spaces 4b to configure the work cell A or the monitoring device 1, as shown in FIG. 3 such that the protective spaces 4, 4a and the additional protective spaces 4b can be differently activated or deactivated in dependence on the trajectory BW of the machine M.

The monitoring device 1, for example, checks the protective spaces 4, 4a superposable with the work spaces 2, 2a of the machine M for a freedom from objects. The monitoring device 1 additionally checks the additional protection spaces 4b as to whether persons are present in these regions.

If the protective spaces 4, 4a and thus the work spaces 2, 2a of the machine M are free of objects and if no persons are present in the additional protective spaces 4b, the work cell A is ready to start and can begin its work.

After the start of the machine M, the protective spaces 4, 4a are deactivated using the data of the trajectory BW of the machine M and the additional protective spaces 4b are still actively monitored by the monitoring device 1.

The machine M can hereby act freely in its work spaces 2, 2a and in the deactivated work spaces 4, 4a and the monitoring device 1 is only active with the evaluation of the monitoring of the additional protective spaces 4b or with the securing of the surroundings of the machine M

It is additionally shown in FIG. 3 with respect to FIG. 2 that the configuration apparatus 5 is preferably provided integrated in the monitoring unit 1, with the configuration apparatus 5 also being able to be physically separate from the monitoring device 1 and from the machine control Ma, as shown in FIGS. 1 and 2.

In other words, the configuration apparatus 5 comprises programmed logic which, for example, the reception unit, the generation unit, the test unit, the acknowledgment unit and the transfer unit can form and can be implemented separately from or integrated in the control unit 1b of the monitoring device 1.

### REFERENCE NUMERAL LIST

1 monitoring device

1a detection unit

1b control unit

2, 2a work space

3 field of vision

4, 4a protective space

4b additional protective space

5 configuration apparatus

A automated and monitored work cell

BW trajectory

K coordinate system

M machine or robot

Ma machine control

S protective fence

Z access

1. A method of configuring and of operating a monitored automated work cell, wherein the monitored automated work cell has at least one dangerous machine and at least one monitoring device, with the method comprising the following steps:
transmitting machine space data defining at least one work space of the dangerous machine to a configuration apparatus for the monitoring device;
generating protective space data by the configuration apparatus using the machine space data, with the protective space data defining at least one protective space of the monitoring device which encompasses the work space of the dangerous machine such that the at least one protective space completely or partly corresponds to the at least one work space or that the at least one protective space is larger than the at least one work space; and
transferring the protective space data to the monitoring device so that the monitoring device monitors the at least one protective space.

2. The method in accordance with claim 1, wherein the machine space data and the protective space data are checked for consistency and the configuration of the at least one protective space of the monitoring device is only released on a correct parameterization and coordination between the machine space data and the protective space data.

3. The method in accordance with claim 1, wherein the machine space data are generated by a machine control of the dangerous machine in dependence on a coordinate system of the dangerous machine.

4. The method in accordance with claim 3, wherein the protective space data are adapted to the coordinate system of the machine.

5. The method in accordance with claim 1, wherein the at least one protective space is changed manually or automatically so that the at least one protective space is increased by at least one additional protective space with respect to the at least one work space.

6. The method in accordance with claim 5, wherein the at least one protective space and the at least one additional protective space are differently activated and deactivated in dependence on a trajectory of the dangerous machine.

7. The method in accordance with claim 1, wherein the steps of transmitting the machine space data, of generating the protective space data, and of transferring the protective space data are carried out in a fully automated manner and the step of releasing the monitored automated work cell is carried out manually.

8. The method in accordance with claim 1, wherein the machine space data define a plurality of work spaces and the protective space data generated from the machine space data correspondingly define a plurality of protective spaces which coincide in a covering manner with the respective work spaces.

9. The method in accordance with claim 1, wherein the machine space data comprise spatial coordinates of the coordinate system of the dangerous machine and are generated in a language specific to the dangerous machine; and wherein the protective space data likewise comprise spatial coordinates of the coordinate system of the dangerous machine and are generated in a language specific to the monitoring device.

10. A configuration apparatus for configuring a monitoring device monitoring an automated work cell, wherein the monitored automated work cell has at least one dangerous machine and the monitoring device has a control unit;
wherein the configuration apparatus comprises
a reception unit for receiving machine space data which define at least one work space of the dangerous machine;
a generation unit for generating protective space data from the machine space data, with the protective space data defining at least one protective space of the monitoring device which encompasses the at least one work space of the dangerous machine such that the at least one protective space completely or partly corresponds to the at least one work space or the protective space at least one is larger than the at least one work space; and
a transfer unit for transferring the protective space data to the control unit of the monitoring device so that the monitoring device monitors the at least one protective space.

11. The configuration apparatus in accordance with claim 10, wherein the at least one dangerous machine is a multi-axial robot.

12. The configuration apparatus in accordance with claim 10, wherein the configuration apparatus is provided physically separate from a machine control of the dangerous machine and from the monitoring device or is physically provided in the monitoring device.

13. The configuration apparatus in accordance with claim 10, wherein the machine space data and the protective space data are based on a common coordinate system.

14. The configuration apparatus in accordance with claim 10, wherein the common coordinate system is the coordinate system of the dangerous machine.

15. The configuration apparatus in accordance with claim 10, wherein the generation unit is adapted to extend the protective space data manually or automatically by a predefinable value range so that the at least one protective space defined by the protective space date is increased by least one additional protective region.

16. The configuration apparatus in accordance with claim 10, wherein a test unit is provided for testing the machine space data and the protective space data for coincidence in their coordinates.

17. The configuration apparatus in accordance with claim 16, wherein an acknowledgment unit is provided for releasing the configuration of the at least one protective space of the monitoring device on consistency between the machine space data and the protective space data.
